(19) United States
(12) Patent Application Publication
(10) Pub. No.: US 2022/0295036 A1
(43) Pub. Date: Sep. 15, 2022

(54) VEHICLE BODY STRUCTURE HAVING CAMERA

(71) Applicant: HONDA MOTOR CO., LTD., Tokyo (JP)

(72) Inventors: Yohei KURIHARA, Tokyo (JP); Kazuo SAKURAI, Tokyo (JP)

(21) Appl. No.: 17/580,724

(22) Filed: Jan. 21, 2022

(30) Foreign Application Priority Data
Mar. 9, 2021 (JP) 2021-037611

(51) Int. Cl. H04N 13/239; H04N 5/225; B60R 11/04

(52) U.S. Cl. CPC H04N 13/239; H04N 5/2253; H04N 5/22521; B60R 11/04; B60R 2011/0026

(57) ABSTRACT

A vehicle body structure having a camera, includes: a light transmissive window defining a cabin; and a camera disposed to oppose a cabin-side surface of the window, wherein the window has a moth-eye structure formed on at least a part of the cabin-side surface located within an image capturing range of the camera.

### TECHNICAL FIELD

The present invention relates to a vehicle body structure having a camera for capturing images around the vehicle.

### BACKGROUND ART

Conventionally, as a technology for preventing reflection on the surface of a display or an optical element, a moth-eye structure having multiple fine bumps (irregularities) arrange on a surface is used.

Also, as a technology for forming a moth-eye structure, a moth-eye transfer mold including a glassy carbon layer having an inverted moth-eye structure over a surface and a method of manufacturing the moth-eye transfer mold are known (see JP6467089B1).

Incidentally, regarding a camera installed in a cabin of an automobile or the like, it is desired to suppress deterioration of the image captured by the camera due to reflection of light by the inner surface of the window and multi-reflection of light incident on and propagating in the window.

On the other hand, the prior art document describes that the moth-eye structure may be applied to lenses for onboard cameras, protective glass, etc. in the field of automobile technology. However, in the aforementioned prior art document, though the exemplary components to which the moth-eye structure may be applied are shown, a concrete way of applying the moth-eye structure to the camera installed in the cabin or members around it is not described.

### SUMMARY OF THE INVENTION

In view of the foregoing background, a primary object of the present invention is to provide a vehicle body structure that can suppress deterioration of the image captured by the camera due to reflection of light by the inner surface (cabin-side surface) of the window and multi-reflection of light incident on and propagating in the window.

To achieve the above object, one aspect of the present invention provides a vehicle body structure having a camera, comprising: a light transmissive window (11) defining a cabin (5); and a camera (21) disposed to oppose a cabin-side surface (11A) of the window, wherein the window has a moth-eye structure (53) formed on at least a part of the cabin-side surface (11A) located within an image capturing range of the camera.

According to this aspect, since at least a part of the cabin-side surface of the window within the image capturing range of the camera is formed with a moth-eye structure, it is possible to suppress deterioration of the image captured by the camera due to reflection of light by the cabin-side surface (inner surface) of the window and multi-reflection of light incident on and propagating in the window.

In the above aspect, preferably, the vehicle body structure further comprises a cover member (37) disposed to cover a space (35) between the window and the camera in the image capturing range of the camera, and the cover member is provided with a heater (38).

According to this aspect, fogging of the cabin-side surface of the window can be prevented due to heating by the heater while preventing the cabin-side surface (inner surface) of the window from reflecting the light entering through the window and reflected by the cover member. Also, according to this aspect, there is no need to provide a surface of the cover member (namely, a surface that could reflect the light that has entered through the window) with a structure for preventing reflection (for example, uneven surface shape), and therefore, the cover member can be simple in structure. Particularly, the omission of the uneven surface shape to simplify the structure of the cover member can result in reduction of the thickness of the cover member, and this improves the transmission of heat generated by the heater to the space between the window and the camera, whereby fogging of the window can be effectively prevented.

In the above aspect, preferably, the moth-eye structure is formed on a film (41) attached to the cabin-side surface of the window, and a part (41A) of the film is sandwiched between the window and the cover member.

According to this aspect, since the film formed with the moth-eye structure is fixed by the cover member stably relative to the cabin-side surface of the window, peeling of the film can be prevented.

In the above aspect, preferably, the moth-eye structure is formed on a film (41) attached to the cabin-side surface of the window, the vehicle body structure further comprises a contact member (45) that is connected to the camera and contacts the window, and a part (41B) of the film is sandwiched between the window and the contact member.

According to this aspect, the film formed with the moth-eye structure is fixed by the contact member stably relative to the cabin-side surface of the window, and thus, peeling of the film can be prevented.

In the above aspect, preferably, the vehicle body structure further comprises a support member (81) that supports the camera, wherein the support member is fixed to the cabin-side surface (11A) of the window to surround the image capturing range of the camera, the moth-eye structure is formed on a film (41L, 41R) attached to the cabin-side surface of the window, and the film is attached to only a region of the cabin-side surface of the window on an inner side of the support member.

According to this aspect, maintenance (for example, replacement) of the film formed with the moth-eye structure can be performed without removing the support member supporting the camera.

In the above aspect, preferably, the camera is a stereo camera (121) having a left camera (21L) and a right camera (21R), and the film includes two parts that are attached to the cabin-side surface of the window so as to correspond to the left camera and the right camera, respectively.

According to this aspect, it is possible to effectively suppress deterioration of the image captured by the stereo camera due to reflection of light by the inner surface of the window and multi-reflection of light incident on and propagating in the window.

According to the foregoing configuration, it is possible to provide a vehicle body structure that can suppress deterioration of the image captured by the camera due to reflection of light by the inner surface of the window and multi-reflection of light incident on and propagating in the window.

### BRIEF DESCRIPTION OF THE DRAWINGS

FIG. 1 is a perspective view of a vehicle provided with a vehicle body structure having a camera according to the first embodiment of the present invention;

FIG. 2 is a perspective view showing a camera unit;

FIG. 3 is a schematic sectional view showing the camera unit and a structure around the camera unit;

FIG. 4 is a schematic sectional view showing an example of a moth-eye structure;

FIG. 5A is an explanatory diagram showing an influence of the light incident on a windshield on an image captured by the camera;

FIG. 5B is an explanatory diagram showing an influence of the light incident on a windshield on an image captured by the camera;

FIG. 6 is a perspective view of a main part of a vehicle provided with a vehicle body structure having a camera according to the second embodiment of the present invention; and

FIG. 7 is an explanatory diagram showing a mount structure of the camera according to the second embodiment as viewed from the cabin side.

### DETAILED DESCRIPTION OF THE INVENTION

In the following, with reference to the drawings, a vehicle provided with a vehicle body structure having a camera according to an embodiment of the present invention will be described.

### First Embodiment

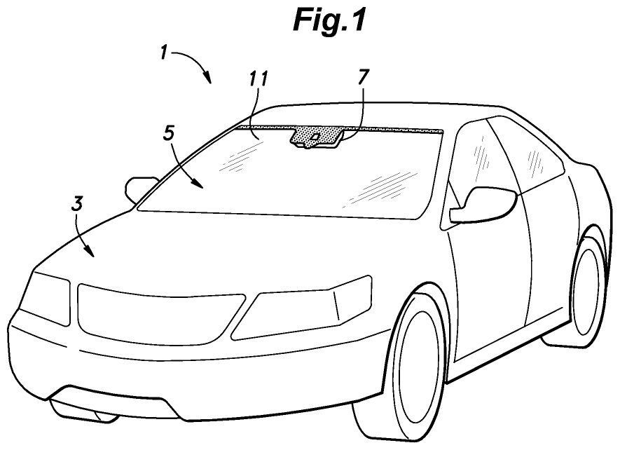

As shown in FIG. 1, an automobile (vehicle) 1 includes a vehicle body 3 that forms a basic skeleton thereof. In a cabin 5 defined by the vehicle body 3, a camera unit 7 for capturing images of the surroundings of the own vehicle is provided. The camera unit 7 is mounted on a cabin-side of a transparent windshield 11 as a window.

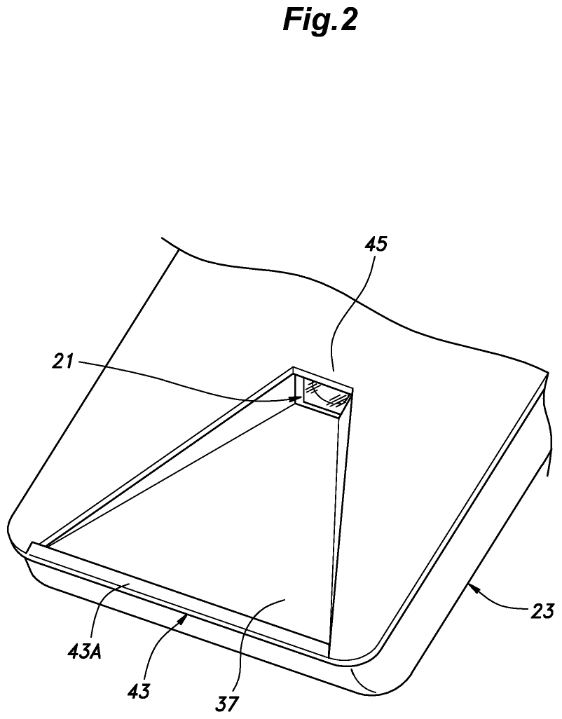

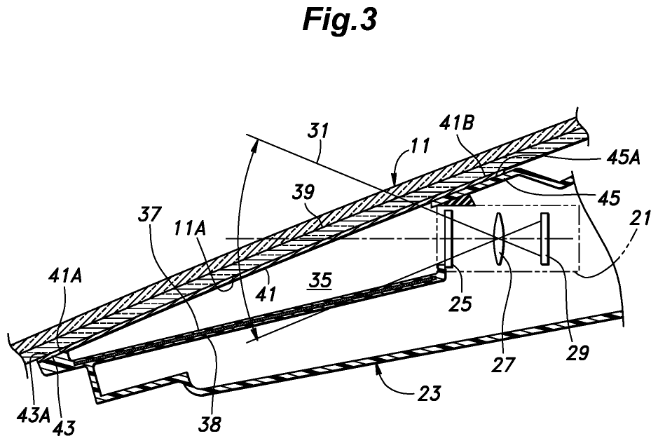

As shown in FIGS. 2 and 3, the camera unit 7 has a camera 21 and a housing 23 that accommodate the camera 21.

The camera 21 has a known hardware configuration. The camera 21 includes a transparent cover plate 25, an optical system 27 including a lens group, an image sensor 29, etc. The camera 21 is disposed to oppose an inner surface (a cabin-side surface that faces the cabin 5) 11A of the windshield 11. The camera 21 captures an image of an exterior of the cabin 5 (such as an object in the surroundings not shown in the drawings) through the windshield 11 in an image capturing range defined by an angle of view 31 thereof.

The housing 23 is fixed to the inner side of the roof (not shown in the drawings) of the automobile 1 and supports the camera 21 such that the image capturing direction is opened. The housing 23 includes a cover member 37 disposed to cover a space 35 between the windshield 11 and the camera 21 in the image capturing range of the camera 21 from below. In other words, the space 35 as viewed in the cross section (see FIG. 3) is a (substantially closed) space surrounded by the windshield 11, the camera 21, and the cover member 37.

The cover member 37 has a substantially flat plate shape and extends obliquely downward from a front part of the camera 21 toward the windshield 11. The cover member 37 is provided with a heater 38. In the image capturing range of the camera 21, heating by the heater 38 prevents fogging of the inner surface 11A of the windshield 11.

The windshield 11 is formed of laminated glass having an intermediate film 39. In the image capturing range of the camera 21, the inner surface 11A of the windshield 11 is formed with a moth-eye structure. More specifically, a film 41 formed with a moth-eye structure (hereinafter referred to as a moth-eye film 41) is attached (pasted) to the inner surface 11A of the windshield 11.

The moth-eye film 41 disposed to cover an area of the inner surface 11A of the windshield 11 within the image capturing range of the camera 21. The moth-eye film 41 is substantially rectangle in view as viewed in a direction substantially perpendicular to the windshield 11.

A lower edge of the cover member 37 is formed with a contact part 43 that protrudes toward the windshield 11. As shown in FIG. 2, the contact part 43 extends in the lateral direction of the vehicle body 3. A lower edge portion 41A of the moth-eye film 41 is sandwiched between a contact surface 43A provided at the contact part 43 of the cover member 37 and the inner surface 11A of the windshield 11. The contact surface 43A is inclined relative to the horizontal direction at an angle substantially the same as that of the inner surface 11A of the windshield 11 as viewed in cross section.

Thereby, the lower edge portion 41A of the moth-eye film 41 is fixed by the cover member 37 stably relative to the inner surface 11A of the windshield 11, and thus, prevent peeling of the moth-eye film 41 can be prevented. Note that it is only necessary that at least a part of the moth-eye film 41 is sandwiched between the cover member 37 and the windshield 11.

Also, an upper wall (contact member) 45 that is connected to an upper portion of the camera 21 to be inclined relative to the horizontal direction at an angle substantially the same as that of the inner surface 11A of the windshield 11 is provided in an upper part of the housing 23 as viewed in cross section. An upper edge portion 41B of the moth-eye film 41 is sandwiched between a contact surface 45A provided at the upper wall 45 of the housing 23 and the inner surface 11A of the windshield 11.

Thereby, the upper edge portion 41B of the moth-eye film 41 is fixed by the upper wall 45 of the housing 23 stably relative to the inner surface 11A of the windshield 11, and thus, peeling of the moth-eye film 41 can be prevented. Note that it is only necessary that at least a part of the moth-eye film 41 is sandwiched between any member that is connected to the camera 21 directly or indirectly and the inner surface 11A of the windshield 11.

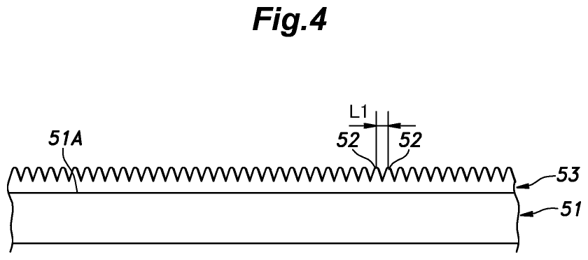

Next, with reference to FIG. 4, an example of the structure of the moth-eye film 41 will be described.

As shown in FIG. 4, for example, the moth-eye film 41 has a structure in which a moth-eye structure 53 having multiple bumps 52 (fine irregularities) is formed on a flat surface 51A of a base film 51 made of a transparent resin. In the state in which the moth-eye film 41 is attached to the windshield 11, arrangement is made such that the tip end portion of each bump 52 is directed substantially inward (toward the cabin 5). The thickness of the moth-eye film 41 is smaller than the thickness of at least the windshield 11.

The multiple bumps 52 have nanometer-scale heights smaller than the wavelength of the radio wave in the millimeter wave band used as the transmission wave. An interval L1 of the multiple bumps 52 is set to 100 to 300 nm, for example.

As the manufacturing method of the moth-eye film 41, any known technology may be used. The base film 51 may be, for example, an acrylic film, a polyester film, a polycarbonate film, and the like. The material forming the moth-eye structure 53 may be, for example, a photocurable resin containing an epoxy-based resin, a urethane-based resin or the like mixed with a photopolymerization initiator, a radical generator, etc.

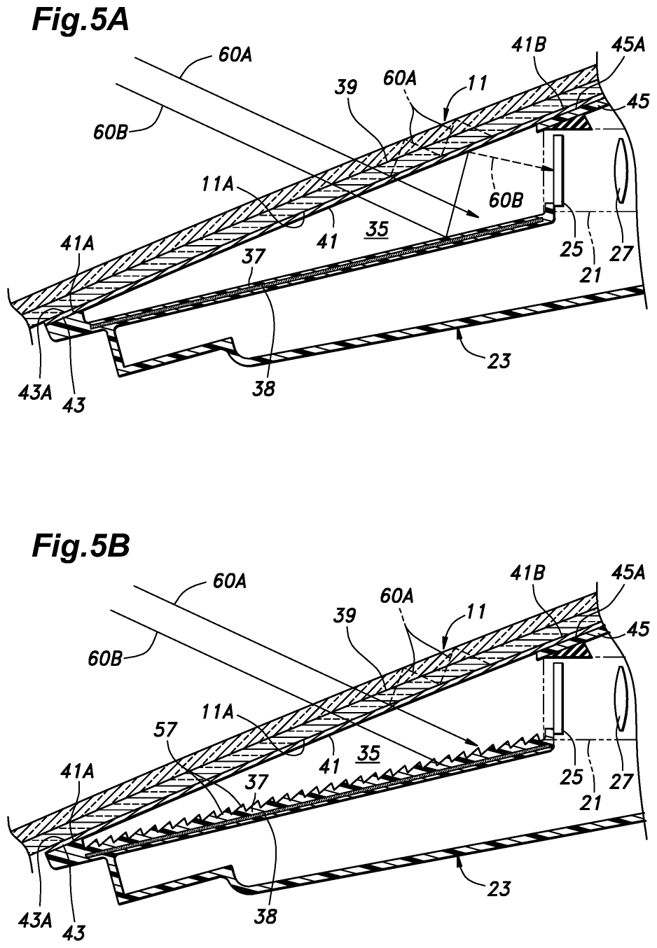

Next, with reference to FIG. 5, description will be made of reflection of light by the inner surface (cabin-side surface) of the windshield and multi-reflection of light propagating in the windshield.

When the moth-eye film 41 is not attached to the windshield 11, an incident light 60A may propagate in the windshield 11 while being reflected multiple times at boundary surfaces thereof, as shown by broken lines in FIG. 5A, for example. Thereby, a false image is created in the image capturing range of the camera 21 and this deteriorates the captured image.

In contrast, in the vehicle body structure according to the present embodiment, since the moth-eye film 41 is attached to the windshield 11, the incident light 60A passes through the windshield 11 so that the multi-reflection at the boundary surfaces inside the windshield 11 is suppressed. As a result, deterioration of the image captured by the camera 21 is suppressed.

Also, when the moth-eye film 41 is not attached to the windshield 11, an incident light 60B that has passed through the windshield 11 is reflected by the surface 37A of the cover member 37 and thereafter is further reflected by the inner surface 11A of the windshield 11 to enter the camera 21, as shown by broken lines in FIG. 5A, for example, and this also deteriorates the image captured by the camera 21.

In contrast, in the vehicle body structure according to the present embodiment, since the moth-eye film 41 is attached to the windshield 11, the further reflection of the incident light 60B by the inner surface 11A of the windshield 11 after being reflected by the surface 37A of the cover member 37 is suppressed, as shown by broken lines in FIG. 5A. As a result, deterioration of the image captured by the camera 21 is suppressed.

Furthermore, in the vehicle body structure according to the present embodiment, the surface 37A of the cover member 37 (namely, the surface that could reflect the light entering through the windshield 11) may be provided with an uneven surface structure 57 to prevent reflection, as shown in FIG. 5B. This suppresses the reflection of the incident light 60B at the surface 37A of the cover member 37, as shown in FIG. 5B. As a result, deterioration of the image captured by the camera 21 is suppressed more effectively.

### Second Embodiment

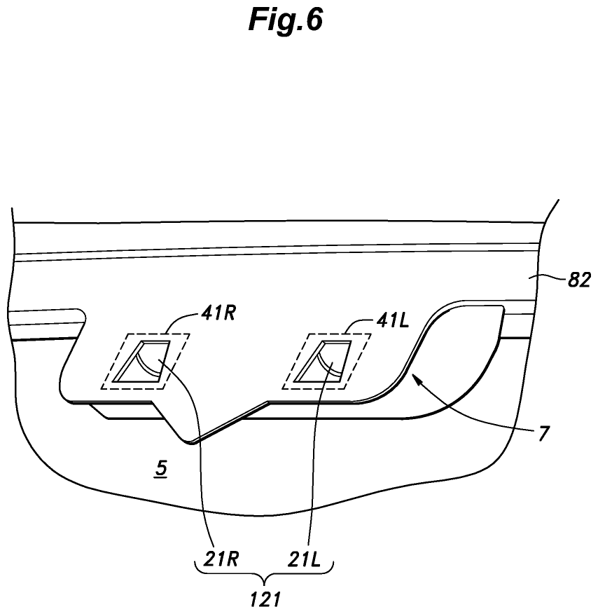

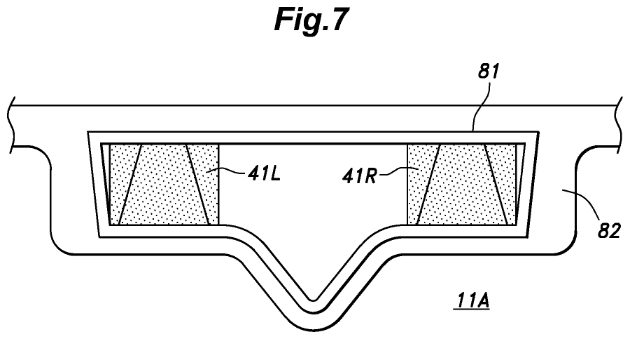

Next, with reference to FIGS. 6 and 7, a vehicle provided with a vehicle body structure having a camera according to the second embodiment of the present invention will be described. In the description of the second embodiment, the components same as those of the first embodiment will be denoted by the same reference signs. Also, the features of the second embodiment that are not particularly mentioned in the following are the same as in the first embodiment, and detailed explanation thereof may be omitted.

As shown in FIG. 6, in the second embodiment, the camera unit 7 provided in the cabin 5 includes a stereo camera 121. The stereo camera 121 has a left camera 21L and a right camera 21R each having the structure same as the aforementioned camera 21, and can generate distance information or the like in the image capturing range based on the parallax between the two cameras 21L, 21R.

As shown in FIG. 7, a bracket 81 for the camera unit 7 is fixed to the inner surface 11A of the windshield 11. The bracket 81 is annular in shape to surround the image capturing ranges of the left camera 21L and the right camera 21R. Note that the bracket 81 does not necessarily have to have a completely continuous annular structure and a part thereof may be cut away. Around the bracket 81, a black ceramic part 82 is formed.

The camera unit 7 is detachably attached to the bracket 81 by engagement claws or the like not shown in the drawings. The camera unit 7 is mounted on the bracket 81 from the cabin 5 side to be fixed on the windshield 11.

In regions of the inner surface 11A of the windshield 11 corresponding to the image capturing ranges of the left camera 21L and the right camera 21R, moth-eye films 41L, 41R are attached. In the present embodiment, two moth-eye films 41L, 41R respectively corresponding to the image capturing ranges of the left camera 21L and the right camera 21R are attached.

The moth-eye films 41L, 41R each have a substantially rectangular shape and a larger size than the image capturing ranges of the left camera 21L and the right camera 21R (here, trapezoid shape) on the inner surface 11A of the windshield 11. The moth-eye films 41L, 41R are disposed in a region surrounded by the bracket 81 on the inner surface 11A of the windshield 11. Thereby, maintenance (for example, replacement) of the moth-eye films 41L, 41R can be performed without removing the bracket 81 supporting the camera unit 7.

Note that a single moth-eye film disposed to cover the image capturing ranges of the left camera 21L and the right camera 21R may be used. Also, a moth-eye film may be disposed over the entire region within the bracket 81. Further, an example of the stereo camera 121 was described in the present embodiment, a monocular camera similar to the camera 21 of the first embodiment may also be used.

Concrete embodiments of the present invention have been described in the foregoing, but the present invention is not limited to the above embodiments and may be modified or altered in various ways. For example, in the above-described embodiments, the inner surface of the window (windshield 11) was formed with a moth-eye structure but the outer surface of the window also may be similarly formed with a moth-eye structure. Further, the window that the camera 21 is disposed to oppose is not limited to the windshield 11 and the camera 21 may be disposed to oppose a rear window or a side window of the vehicle.

1. A vehicle body structure having a camera, comprising:
a light transmissive window defining a cabin; and
a camera disposed to oppose a cabin-side surface of the window,
wherein the window has a moth-eye structure formed on at least a part of the cabin-side surface located within an image capturing range of the camera.

2. The vehicle body structure according to claim 1, further comprising a cover member disposed to cover a space between the window and the camera in the image capturing range of the camera, and
the cover member is provided with a heater.

3. The vehicle body structure according to claim 2, wherein the moth-eye structure is formed on a film attached to the cabin-side surface of the window, and
a part of the film is sandwiched between the window and the cover member.

4. The vehicle body structure according to claim 1, wherein the moth-eye structure is formed on a film attached to the cabin-side surface of the window,
the vehicle body structure further comprises a contact member that is connected to the camera and contacts the window, and
a part of the film is sandwiched between the window and the contact member.

5. The vehicle body structure according to claim 1, further comprising a support member that supports the camera,
wherein the support member is fixed to the cabin-side surface of the window to surround the image capturing range of the camera,
the moth-eye structure is formed on a film attached to the cabin-side surface of the window, and
the film is attached to only a region of the cabin-side surface of the window on an inner side of the support member.

6. The vehicle body structure according to claim 5, wherein the camera is a stereo camera having a left camera and a right camera, and
the film includes two parts that are attached to the cabin-side surface of the window so as to correspond to the left camera and the right camera, respectively.
